(19) United States
(12) Patent Application Publication
(10) Pub. No.: US 2019/0075973 A1
(43) Pub. Date: Mar. 14, 2019

(54) SUPPLEMENT DRINKING BOTTLE AND ACCESSORIES THEREOF

(71) Applicants: Brandon CHARLESON, Valley Springs, CA (US); John REYES, Valley Springs, CA (US)

(72) Inventors: Brandon CHARLESON, Clearfield, UT (US); John REYES, Valley Springs, CA (US)

(21) Appl. No.: 16/081,866

(22) PCT Filed: Mar. 2, 2016
(86) PCT No.: PCT/US2016/020522

§ 371 Date: Aug. 31, 2018

(51) Int. Cl. A47J 43/27; B65D 47/14; B01F 13/00

(52) U.S. Cl. CPC A47J 43/27; B65D 21/086; B01F 13/0022; B65D 47/142

(57) ABSTRACT

Supplement mixing bottles (200) are provided herein. An example bottle includes a tubular body (204) having a plurality of ringed sections (206) that are progressively smaller in diameter from an open end to a bottom end. The bottle includes an agitator ring (100, 300) with static blades (304, 306) and a cap (202).

### FIELD OF THE PRESENT DISCLOSURE

Embodiments are directed to accessories for drinking containers and, more particularly but not exclusively, supplement agitators for supplement drinking bottles. Additionally or alternatively, embodiments are directed to drinking containers and, more particularly but not exclusively, to supplement drinking bottles.

### SUMMARY

According to one aspect, the present disclosure is directed to an agitator ring, comprising: (a) an annular ring body having an outer surface and an inner surface, a diameter of the annular ring being defined relative to a central axis; (b) a plurality of static fins extending from the inner surface towards the central axis; and (c) wherein the outer surface of the annular ring body is configured to mate with a drink container.

According to another aspect, the present disclosure is directed to a bottle, comprising: (a) a tubular body having a plurality of ringed sections that are progressively smaller in diameter from an open end to a bottom end; (b) an agitator ring comprising: (i) an annular ring body having an outer surface and an inner surface, a diameter of the annular ring being defined relative to a central axis; (ii) a plurality of static fins extending from the inner surface towards the central axis; and (iii) wherein the outer surface of the annular ring body is configured to mate with an inner surface of the tubular body; and (c) a cap that releaseably couples with the open end of the tubular body.

According to yet another aspect, the present disclosure is directed to a collapsible bottle, comprising: (a) a collapsible and tubular body having a plurality of ringed sections that are progressively smaller in diameter from an open end to a bottom end; (b) an agitator ring comprising: (i) an annular ring body having an outer surface and an inner surface, a diameter of the annular ring being defined relative to a central axis; (ii) a plurality of static fins extending from the inner surface towards the central axis; and (iii) wherein the outer surface of the annular ring body is configured to mate with an inner surface of the collapsible and tubular body; and (c) a cap that releaseably couples with the open end of the collapsible and tubular body.

Some embodiments include a bottle configuration, while other embodiments comprise a cup or any other similar sealed/sealable container. The containers of the present disclosure include rigid, non-collapsible embodiments, as well as deformable, elastic, collapsible embodiments. Some embodiments comprise fixed agitator rings with static blades while other embodiments comprise removable agitator rings.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1A is top perspective view of an example agitator ring for a drinking container according to one embodiment.

FIG. 1B is a perspective view of another example agitator ring for a drinking container according to one embodiment

FIG. 2 is side view of a collapsible drinking bottle in which the bottle is in a fully extended or non-collapsed state according to one embodiment.

FIG. 3 is a side view of the collapsible drinking bottle in which the bottle is in a fully collapsed state according to one embodiment.

FIG. 4 is a bottom plan view of the fully collapsed bottle shown in FIG. 2.

FIG. 5 is a bottom perspective view of the bottle of FIG. 2.

FIG. 6 is a top perspective view of the bottle of FIG. 2 without the lid according to one embodiment.

FIG. 7 is a side perspective view of the bottle of FIG. 2 that has been collapsed from the fully extended state to a partially collapsed state according to one embodiment.

FIG. 8 is a cross sectional view of a portion of the bottle of FIG. 6.

FIG. 9 is a cross sectional view of a collapsed drinking bottle with the agitator ring of FIG. 1B disposed within.

FIG. 10 is an exploded view of a drinking bottle in combination with the agitator ring of FIG. 1B disposed within.

FIG. 11 is an exploded view of a drinking bottle in combination with a fluid filter insert.

FIG. 12 is a perspective view taken from below of a drinking bottle cap according to alternative embodiment for use with the bottle of FIG. 6.

FIG. 13 is a cross sectional view of drinking bottle cap of FIG. 12.

### DESCRIPTION OF PREFERRED EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

In general, the present disclosure is directed to various containers that include agitator blades for mixing a fluid within the container with one or more additives, such as protein powders, vitamins, supplements, and so forth. The containers can include bottles, cups, and other vessels that receive and retain a liquid.

In some embodiments, an agitating container of the present disclosure is collapsible and expandable between a collapsed configuration and an expanded configuration. According to some embodiments, these containers comprise an agitator.

According to some aspects, an agitator device for these containers is provided. In some embodiments, the agitator device is an agitator ring with protruding blades.

In one embodiment, a container comprises a tubular body having a plurality of ringed sections that are progressively smaller in diameter from an open end to a bottom end. Thus, the container tapers from top to bottom. In some embodiments, the bottom of the container is flared to support the container when sitting on a surface.

The agitator container includes an agitator ring having an annular ring body with an outer surface and an inner surface. A diameter of the annular ring is defined relative to a central axis and the diameter is selected so as to allow the outer surface of the agitator ring to contact an inner surface of the tubular body.

The agitator ring includes a plurality of static fins that extend from the inner surface towards the central axis.

In some embodiments, a cap that releaseably couples with the open end of the tubular body is provided for sealing the agitating container.

These and other advantages will be described in greater detail below with reference to the Figures.

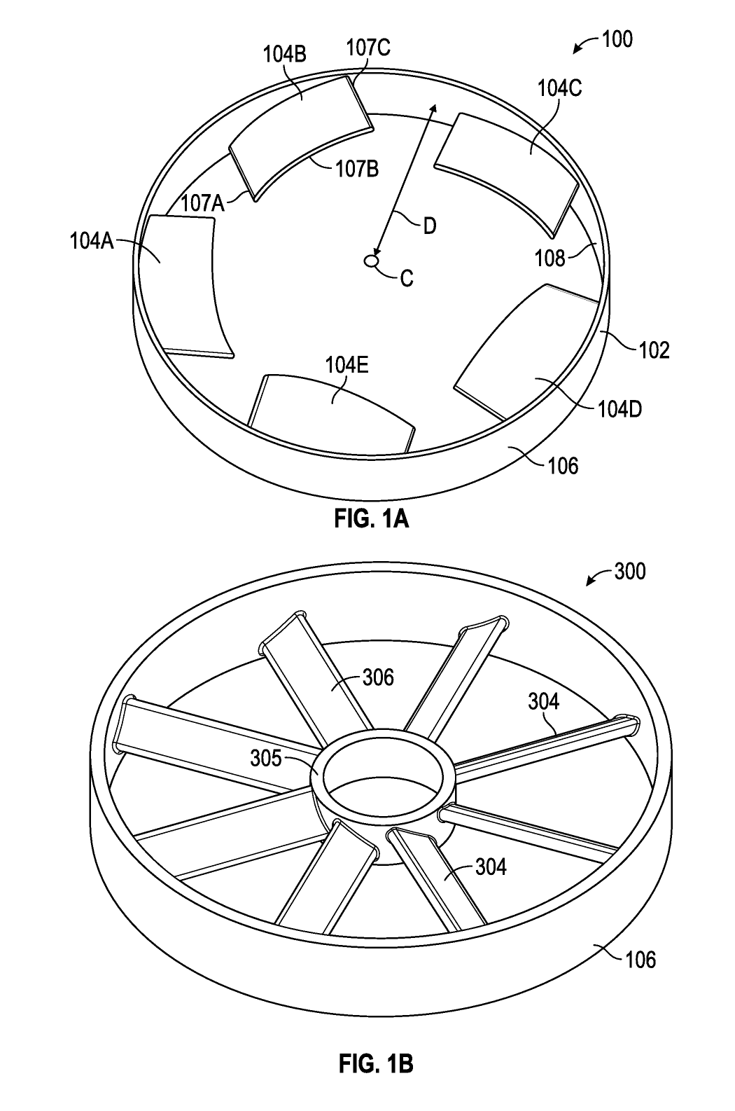

Referring now to FIG. 1A, an example agitator ring 100 is illustrated. The agitator ring 100 comprises an annular ring body 102 and a plurality of agitator elements. In this embodiment, the agitator elements are static fins 104A-E. A diameter D of the annular ring body 102 is defined relative to a central axis C. As mentioned above, the diameter D of the annular ring body 102 is configured to mate with a container body, as will be described in greater detail below.

The annular ring body 102 comprises an outer surface or sidewall 106 and an inner surface or sidewall 108. The annular ring body 102 comprises a thickness (e.g., distance between inner surface 108 and outer surface 106) and a height that are selected according to design requirements.

The plurality of static fins 104A-E includes five fins in some embodiments. It will be understood that any number of fins can be selected. The number of fins can be selected based upon the agitation or mixing requirements for the agitator ring 100.

In some embodiments, adjacent ones of the plurality of static fins are placed in spaced apart relationship to one another. For example, fin 104A is spaced apart from fin 104E and 1048. The distance between adjacent fins is selectable, in some embodiments.

In one embodiment, each of the plurality of static fins 104A-E is an arcuate segment. The size and shape of each of the plurality of static fins 104A-E is identical. In other embodiments, the size and shape of the plurality of static fins 104A-E are different from one another.

According to some embodiments, the plurality of static fins 104A-E are rectangular tabs comprising three linear edges. For example, the fin 104B has a first linear edge 107A, a second liner edge 107B, and a third linear edge 107C. The first and third linear edges 107A and 107C are aligned in parallel with one another. The second or middle linear edge 107B has a curvilinear shape.

In some embodiments, each of the plurality of static fins 104A-E is cantilevered from the inner surface 108 of the annular ring body 102. Each of the plurality of static fins 104A-E have a length that is defined by a distance that the plurality of static fins 104A-E extend away from the inner surface 108 of the annular ring body 102 towards the central axis C.

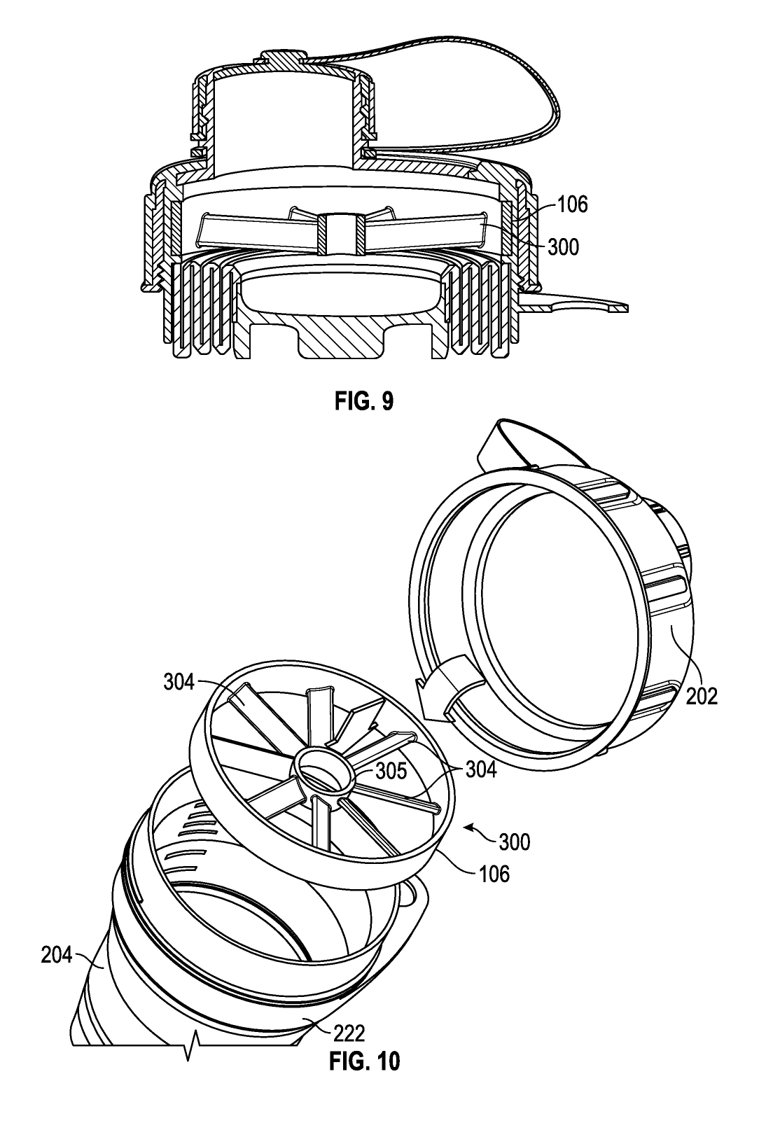

FIG. 1B illustrates another embodiment of an agitator propeller ring 300 that has an outer ring having an outer surface 106. The agitator ring 300 includes an annular hub 305. In this embodiment, the plurality of agitator elements are a plurality of blades, such as blades 304 and 306, which extend from the outer ring to the annular hub 305. The blades 304 and 306 are set at an angle to promote agitation of contents within a bottle when the agitator ring 300 is installed in the bottle, as illustrated in FIGS. 9 and 10. In some embodiments the blades extend coaxially with and between the outer ring and inner hub and are inclined widthwise at an angle relative to the plane in which the outer ring and inner hub extend circumferentially. Angling of the blades increases the surface area of the blades to which the contents are exposed. When the bottle is shaken, the contents will move across the blades 304 and 306, which induces a mixing of the contents as the contents pass across the blades.

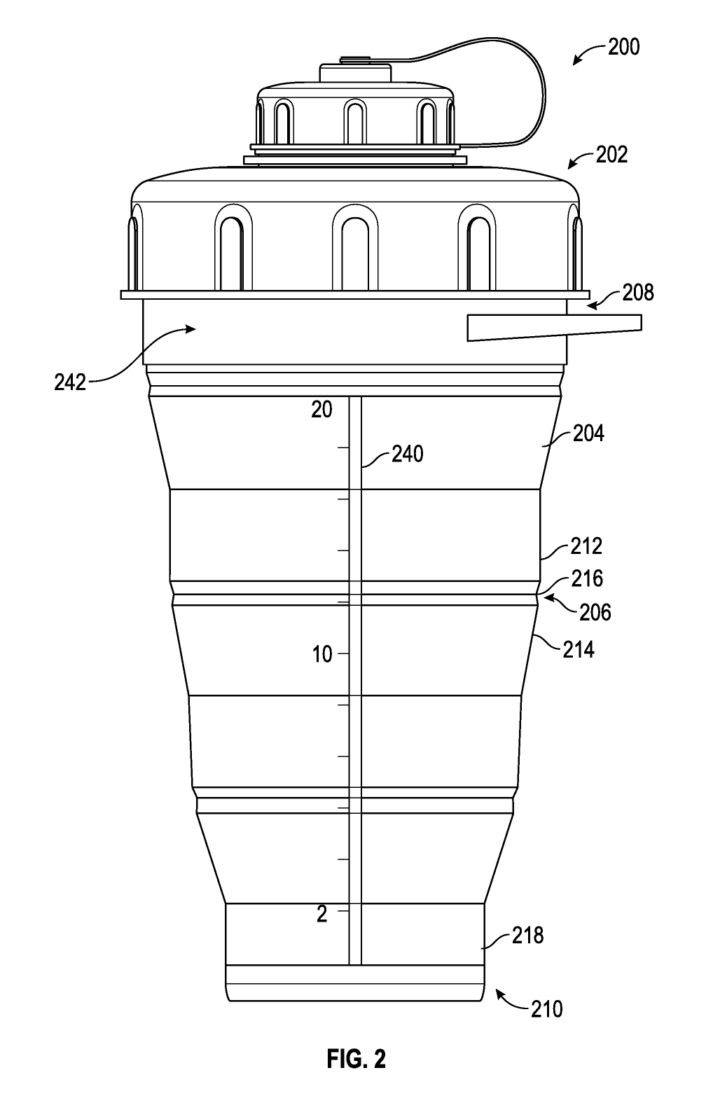

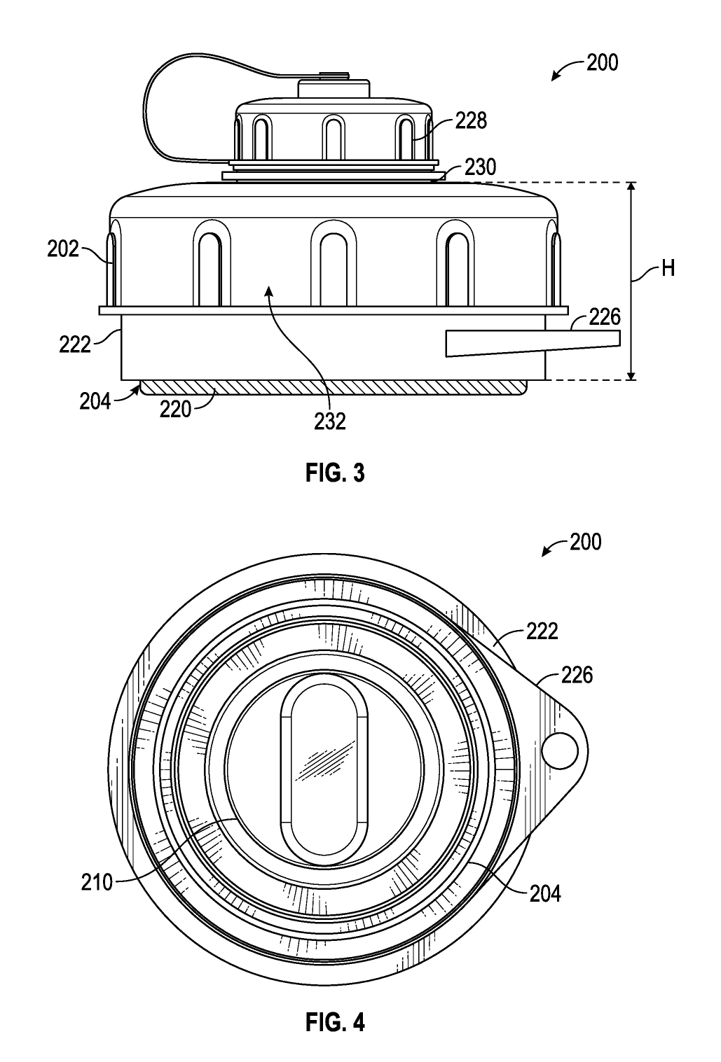

FIG. 2 illustrates an example bottle 200 that incorporates the agitator ring 100 of FIG. 1A or agitator ring 300 of FIG. 1B. The bottle 200 comprises a cap 202 and a tubular body 204. In this embodiment, the tubular body 204 is a collapsible and tubular body that is fabricated from an elastic material such as silicone. In another embodiment, the tubular body 204 is non-collapsible.

Any other suitable elastic material can be utilized. The material selected can also include an elastic material that is food grade, in some embodiments.

In some embodiments, the tubular body 204 is comprised of a plurality of ringed sections 206. In one embodiment the plurality of ringed sections, such as ringed section 206 are progressively smaller in diameter from an open end 208 (illustrated in FIG. 2 covered by the cap 202) to a bottom end 210.

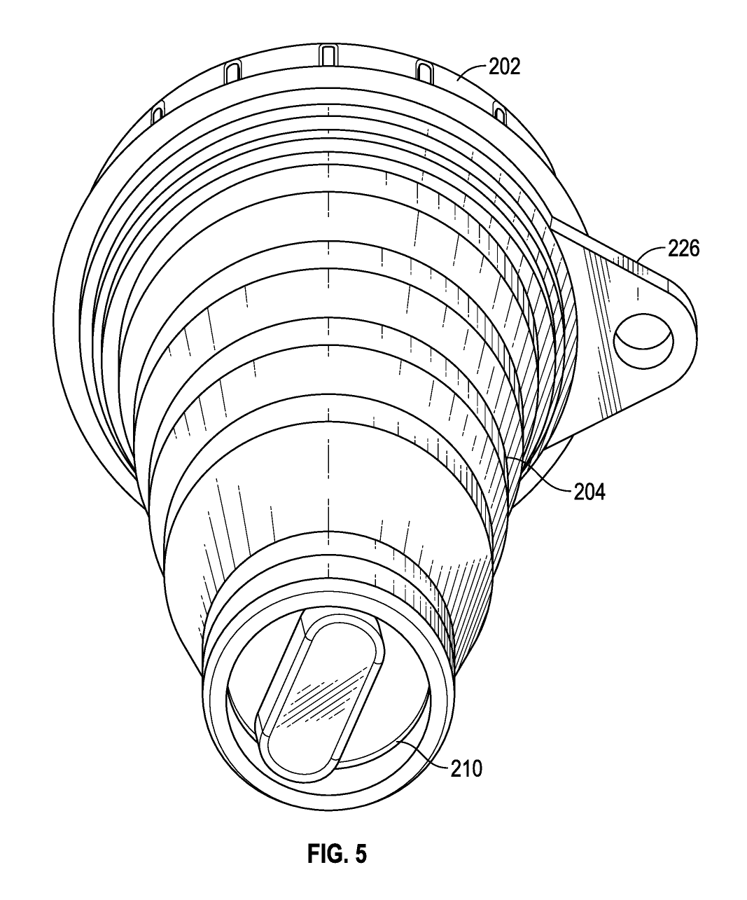

The ringed section 206 comprises a downwardly angled section 212 and an upwardly angled section 214 which are separated by a grooved section 216. These ringed sections are shaped to facilitate collapsing of the tubular body 204 into a puck or collapsed configuration (see FIGS. 3 and 4). Each of the ringed sections collapses or nests concentrically based on the varying diameter of the ringed sections.

In some embodiments, the tubular body 204 comprises a transparent strip 240 that extends vertically at least partially between the open end 208 and the bottom end 210, providing a view of contents within the bottle 200. The tubular body 204 can also comprise printed indicia 242 that indicate measured volume within the tubular body 204. The printed indicia 242 extend alongside the transparent strip 240. A level of contents viewed through the transparent strip 240 aligns with the printed indicia to allow the user to determine a volume of contents within the tubular body 204.

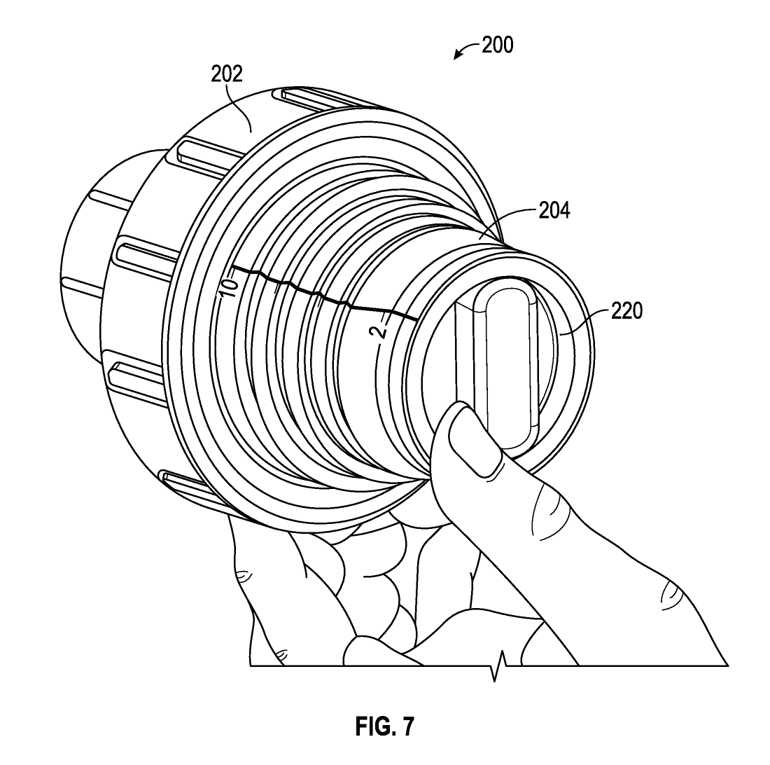

When the bottle 200 is at least partially collapsed, as in FIG. 7, any remaining contents within the tubular body 204 are measurable based on the printed indicia still showing on the tubular body 204. Thus, in some embodiments, the transparent strip 240 is not required and content volume is estimated or measured based on the indicia showing after collapsing of the tubular body 204. For example, if the tubular body 204 has indicia that indicate a total of 20 fluid ounces, if the tubular body 204 is collapsed half way, the indicia of 10 fluid ounces is viewable, while the indicia of 20 to 10 fluid ounces is hidden due to collapsing of the tubular body 204.

In some embodiments, a rigid cup 218 is associated with the bottom end 210. The rigid cup 218 provides a means for extending the tubular body 204 from a collapsed to an extended configuration. For example, a user can pull down on the rigid cup 218 to extend the tubular body 204.

The rigid cup 218 comprises a flared bottom portion 220 that provides both a stabilizing base to the bottle 200 and capture point for a user's hand to assist in extending the tubular body 204. The flared bottom portion 220 is also illustrated in FIG. 6.

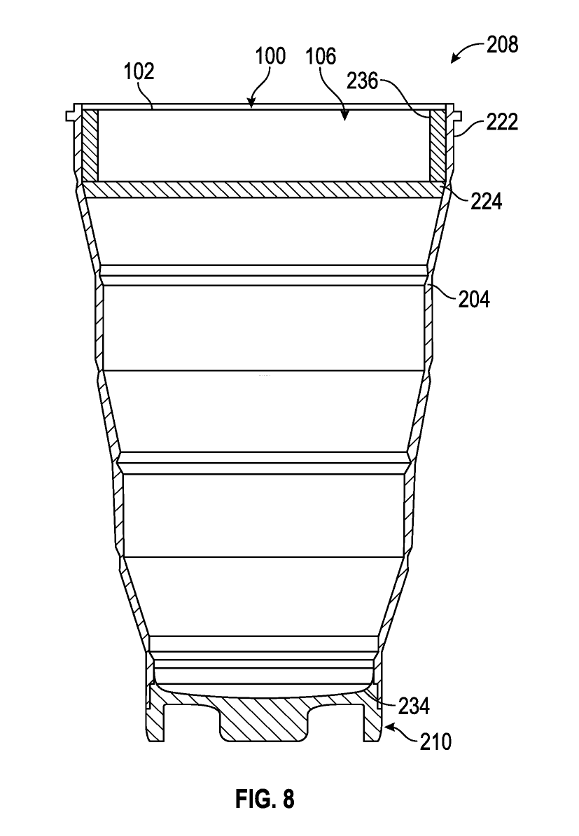

Referring to FIG. 6, the tubular body 204 is provided with a securement ring 222 that is associated with the open end 208. In some embodiments, the securement ring 222 is provided with support tabs, such as support tab 224. The agitator ring 100 of FIG. 1 (or agitator ring 300 of FIG. 1B) is configured to fit into the tubular body 204, being supported on the support tabs. This configuration is illustrated in FIG. 8.

In some embodiments, the securement ring 222 is threaded and releaseably receives the cap 202 thereon.

As illustrated in FIG. 3, the cap 202 and securement ring 222 cooperate together and comprise a height H. The height H allows for the tubular body 204 to collapse and nest within the cap 202 and securement ring 222. In one embodiment, the flared bottom portion 220 extends below the securement ring 222 when the bottle 200 is in a collapsed configuration, as in FIG. 3.

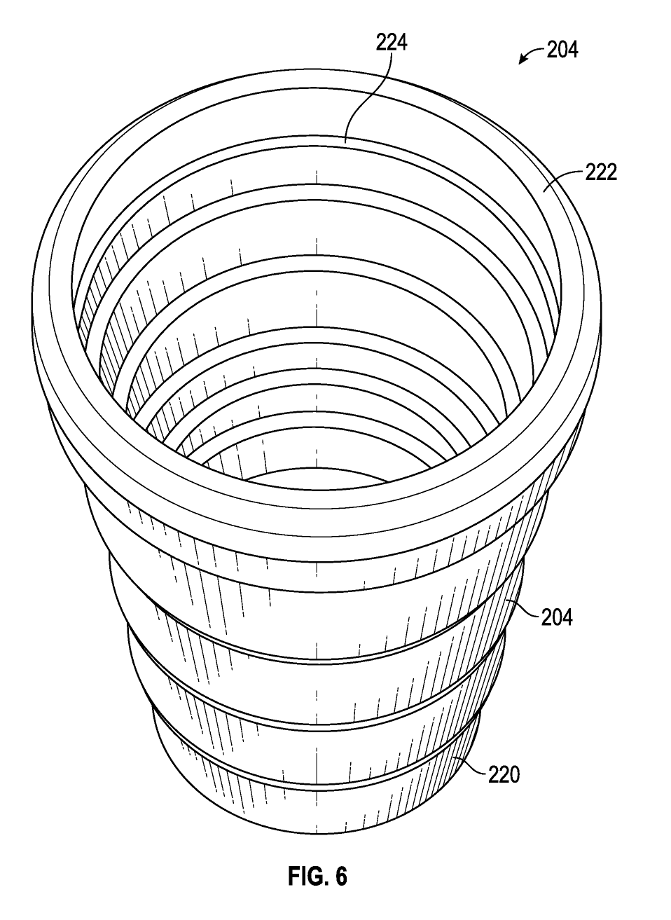

In one embodiment, the cap 202 comprises a loop 226 that receives, for example, a carabiner. Another view of the loop 226 is illustrated in FIG. 5.

According to some embodiments, the cap 202 comprises a secondary cap 228 that covers a pouring port 230. The cap 202 comprises a ribbed outer peripheral surface 232 and a threaded inner surface that mates with the tubular body 204, and specifically the securement ring 222.

Referring now to FIG. 8, the tubular body 204 of FIGS. 2-7 is illustrated and can be utilized with the agitator ring 100 of FIG. 1A or agitator ring 300 of FIG. 1B. The tubular body 204 is illustrated with securement ring 222 and the rigid cup 218. The support tabs, such as support tab 224 are disposed below the agitator ring 100. In one embodiment, the rigid cup 218 comprises a rounded surface 234 that facilitates agitation of the contents of the tubular body 204 (when the cap 202 is coupled to the tubular body 204).

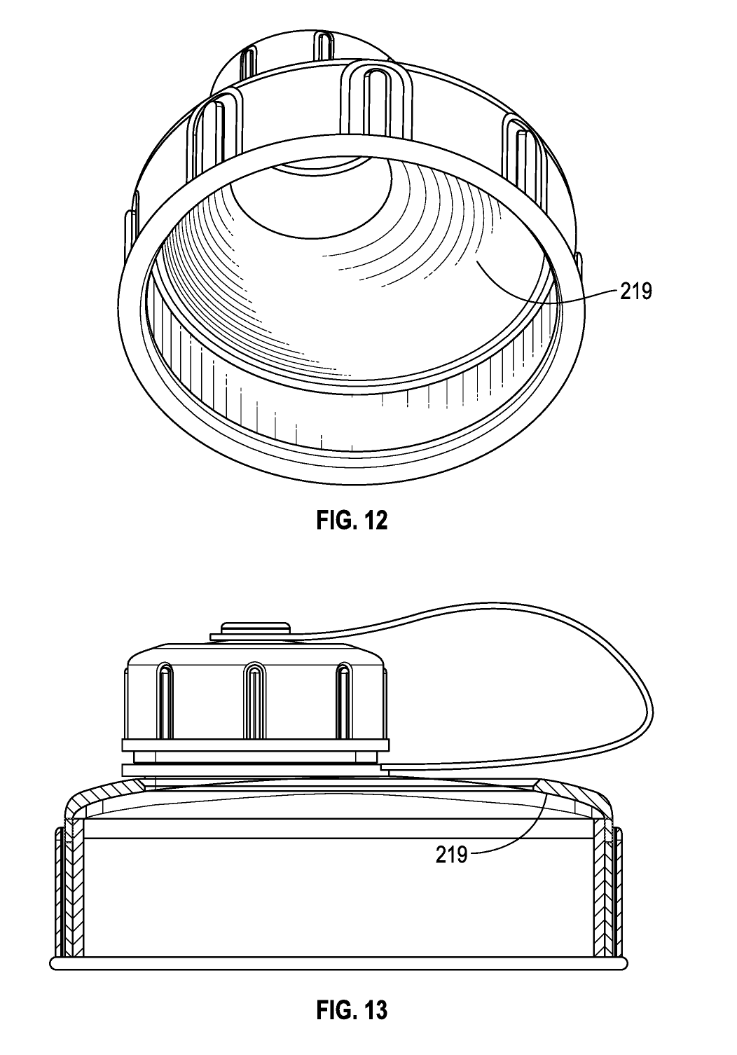

In some embodiments, the cap 202 also comprises a rounded surface that complements the rounded surface 234 of rigid cup 218 to facilitate agitation. The cap with the rounded surface according to some embodiments is illustrated in perspective and cross-sectional views of FIGS. 12 and 13. An interior rounded surface 219 of the underside of the cap is a spherical like surface.

While the embodiment of FIG. 8 contemplates the agitator ring 100 being releaseably associated with the tubular body 204, the agitator ring 100 can be fixedly attached or integrated into the tubular body 204.

In one embodiment, the agitator ring 100 can compressively engage an inner surface 236 of the tubular body 204. More specifically, the outer surface 106 of the annular ring body 102 contacts the inner surface 236 of the securement ring 222 of the tubular body 204.

In some embodiments, a user can introduce one or more powders or liquids into the bottle or container of the present disclosure. The user seals the cap onto the tubular body (whether the tubular body is collapsible or rigid). The user then agitates the contents of the bottle by shaking. The plurality of static fins of the agitator ring cause the contents to mix thoroughly during the shaking process.

When finished, the user can remove the agitator ring (in embodiments where the agitator ring is not fixed into the tubular body) and collapse the bottle into a collapsed configuration, as illustrated in FIG. 3. In embodiments where the bottle is initially collapsed, the user can first extend the tubular body to any desired length prior to introducing liquids or powders therein.

In some embodiments, the present disclosure is embodied as a container such as a canteen and shaker bottle that is constructed to expand to an approximately 20-24 fluid ounce size while being able to collapse into a “puck-like” size. These containers offer a more convenient way to travel with in the event it is not used. As a result, the athlete/fitness enthusiast will also be able to use this bottle as an everyday beverage holder (both cold and hot), as it will not take up valuable space in their gym bag, backpacks and even women's purses. This will allow them to truly have a daily use bottle that fits their everyday active lifestyle. Tactical, first responders, special operations and all military members will also have a way to travel with a collapsible hydration bottle to their deployed location as well as carry it every day as an option making it convenient to pack into their luggage and/or carry it on their person every day.

As mentioned above, some embodiments of containers of the present disclosure are configured or constructed to expand into an approximate 20-24 fluid ounce size bottle and collapsed into a “puck-like” shape as compact as possible for ease of travel use.

A rounded bottom surface, such as a slight oval curve can be utilized to reduce powder build up and make it easier to clean. This also creates a washing mixing motion to allow the powder to mix more effectively. The cap is also slightly rounded on the inside, in some embodiments, to allow powder to flow (minimal crevices). Rubberized large ribbed grips on top and bottle lid to allow for better grip when tightening/loosening in all weather climates. Large threads on the bottle cap can be utilized in some embodiments to prevent cross-threading. Gaskets can be employed on both the cap and secondary cap to prevent leaks. An off center screw on cap allows for ease of use and mitigated spilling.

In FIG. 9, the agitator ring 300 of FIG. 1B is illustrated in combination with a bottle 200 as in FIGS. 3 and 4. The agitator ring 300 resides within a space created by the cap 202 and securement ring 222 when the bottle 200 is in its collapsed configuration.

In FIG. 10, the agitator ring 300 is illustrated as being placed into the securement ring 222. To retain the agitator ring 300 the cap 202 is threaded onto the securement ring 222, capturing the example agitator ring 300 inside.

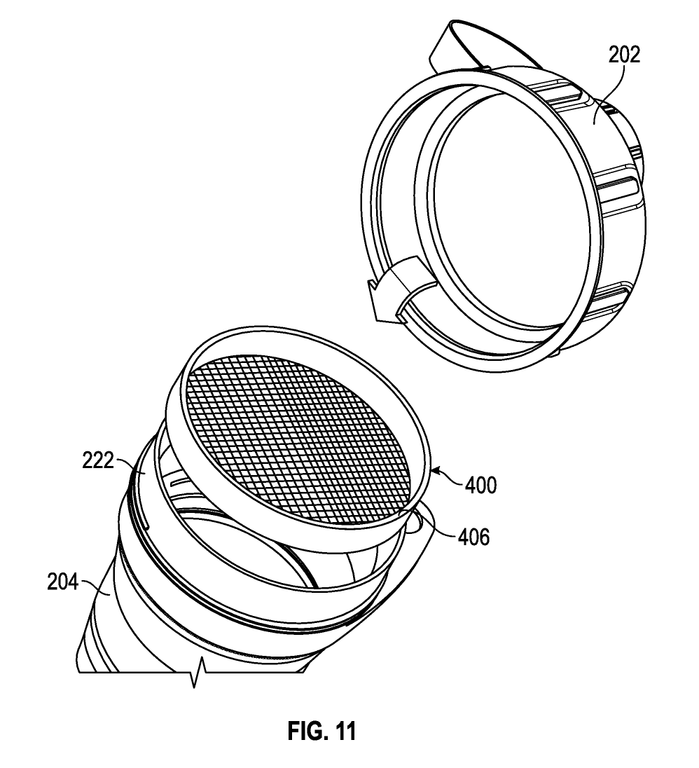

In some embodiments, components of the containers are constructed from food grade silicon and allow for hot and frozen beverages. The agitator ring is utilized in some embodiments to mix powdered drinks more efficiently. In some embodiments a replaceable water filter can be substituted in place of the agitator ring to allow consumers to put unfiltered water into the bottle and enjoy filtered water. For example, in FIG. 11 an example filter disk 400 is illustrated as being placed into the securement ring 222 of a tubular body 204 of a bottle (such as bottle 200 of FIGS. 3 and 4). To retain the example filter disk 400 the cap 202 is threaded onto the securement ring 222, capturing the example filter disk 400 inside.

In some embodiments, an agitator ring and filter disk can be utilized in combination. In one embodiment the agitator ring is placed above (closer to the cap) the filter disk. In another embodiment the filter disk is placed above (closer to the cap) the agitator ring.

The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

1. An agitator ring, comprising:
an annular ring body having an outer surface and an inner surface, a diameter of the annular ring being defined relative to a central axis;
a plurality of agitator elements extending from the inner surface towards the central axis; and
wherein the outer surface of the annular ring body is configured to mate with a drink container.

2. The agitator ring according to claim 1, wherein said plurality of agitator elements are a plurality of blades spaced apart from one another, each one of said blades extending between the annular ring and a central inner hub.

3. The agitator ring according to claim 2, wherein at least one of said blades is inclined widthwise relative to the plane in which the annular ring extends circumferentially.

4. The agitator ring according to claim 1, wherein said plurality of elements are a plurality of static fins; and wherein adjacent ones of the plurality of static fins are placed in spaced apart relationship to one another.

5. The agitator ring according to claim 4, wherein each of the plurality of static fins is an arcuate segment.

6. The agitator ring according to claim 1 wherein the annular ring body is configured to rest on an annular shoulder or plurality of tabs of the drink container.

7. The agitator ring according to claim 1, wherein the plurality of agitator elements comprise static fins, wherein said static fins are rectangular tabs comprising three linear edges, and further wherein the plurality of static fins are cantilevered from the inner surface.

8. The agitator ring according to claim 7, wherein a middle linear edge of the three linear edges is curved.

9. A bottle, comprising:
a tubular body having a plurality of ringed sections that are progressively smaller in diameter from an open end to a bottom end;
an agitator ring comprising:
an annular ring body having an outer surface and an inner surface, a diameter of the annular ring being defined relative to a central axis;
a plurality of static fins extending from the inner surface towards the central axis; and
wherein the outer surface of the annular ring body is configured to mate with an inner surface of the tubular body; and
a cap that releaseably couples with the open end of the tubular body.

10. The bottle according to claim 9, wherein the tubular body is collapsible and the plurality of ringed sections are elastic.

11. The bottle according to claim 9, wherein the bottom end comprises a rigid cup.

12. The bottle according to claim 11, wherein the open end of the tubular body has a securement ring with a height and a remainder of the tubular body with the rigid cup nest within the securement ring when in a collapsed configuration.

13. The bottle according to claim 12, wherein the annular ring body is configured to rest on a plurality of tabs or annular shoulder of the securement ring.

14. The bottle according to claim 9, wherein the annular ring body is fixedly integrated into the securement ring.

15. The bottle according to claim 9, wherein the tubular body comprise a transparent strip that extends vertically at least partially between the open end to the bottom end, providing a view of contents within the bottle.

16. The bottle according to claim 9, wherein the cap comprises a ribbed outer peripheral surface and a threaded inner surface that mates with the cap.

17. The bottle according to claim 9, wherein the cap comprises a pouring port that is covered with a secondary cap.

18. The bottle according to claim 9, wherein the cap and the bottom end each comprise curved surface to facilitate agitation of fluid within the bottle.

19. A collapsible bottle, comprising:
a collapsible and tubular body having a plurality of ringed sections that are progressively smaller in diameter from an open end to a bottom end;
an agitator ring comprising:
an annular ring body having an outer surface and an inner surface, a diameter of the annular ring being defined relative to a central axis;
a plurality of agitator elements extending from the inner surface towards the central axis; and
wherein the outer surface of the annular ring body is configured to mate with an inner surface of the collapsible and tubular body; and
a cap that releaseably couples with the open end of the collapsible and tubular body.

20. The collapsible bottle according to claim 19, wherein the plurality of ringed sections each comprise a downwardly angled section and an upwardly angled section which are separated by a grooved section.

21. The collapsible bottle according to claim 19, wherein the plurality of agitator elements are a plurality of blades spaced apart from one another, each one of said blades extending between the inner surface and central axis and configured to mix a supplement into a fluid sealed within the collapsible and tubular body.

22. The collapsible bottle according to claim 19, wherein the open end of the collapsible and tubular body has a securement ring with a height and a remainder of the collapsible and tubular nests within the securement ring when in a collapsed configuration.
